(19) United States
(12) Patent Application Publication
(10) Pub. No.: US 2025/0155730 A1
(43) Pub. Date: May 15, 2025

(54) CHROMA ENHANCEMENT OPTICAL LENS DEVICE FOR COMPENSATING RED AND GREEN COLOR DEFICIENT VISION AND METHOD THEREOF

(71) Applicant: FORESIGHT OPTICAL LTD., Tainan (TW)

(72) Inventors: YUE-CHANG TSAI, Tainan (TW); TIEN-SHU WU, Tainan (TW); YEN-TING WU, Tainan (TW)

(21) Appl. No.: 18/601,044

(22) Filed: Mar. 11, 2024

(30) Foreign Application Priority Data
Nov. 15, 2023 (TW) 112144122

(51) Int. Cl. G02C 7/10

(52) U.S. Cl. CPC G02C 7/104; G02C 7/107

(57) ABSTRACT

A compensation method of optical lens includes: providing a lens body with an optical filter, with the lens body having an interference light absorbance portion through which a light beam to pass; providing a first green-confusion absorbance region on the interference light absorbance portion, with the first green-confusion absorbance region having a first blue-green absorbance peak portion; providing a second yellow orange-confusion absorbance region on the interference light absorbance portion, with the second yellow orange-confusion absorbance region having a second yellow-orange absorbance peak portion; and the first blue-green absorbance peak portion absorbing at least one blue-green light while the second yellow-orange absorbance peak portion absorbing at least one yellow-orange light to provide red and green chroma enhancement in vision.

### BACKGROUND OF THE INVENTION

### 1. Field of the Invention

The present invention relates to a chroma enhancement optical lens device for compensating red and green color deficient vision and method thereof. Particularly, the present invention relates to the chroma enhancement optical lens device for compensating red and green color deficient vision and method thereof suitable for color deficiencies of blue green color and yellow orange.

### 2. Description of the Related Art

U.S. Pat. No. 10,534,117, entitled “Optical filters and methods for making the same,” discloses an optical filter and a manufacturing method thereof. The manufacturing method of the optical filter includes the step: diffusing multiple dyes dissolved in a solvent into a transparent polymeric substrate at a tinting temperature, with at least one of the dyes being a narrowband absorber dye.

As mentioned above, the manufacturing method of the optical filter further includes the step: removing the solvent from the transparent polymeric substrate; wherein the solvent is selected to sufficiently swell the polymeric substrate to facilitate diffusion of the dyes into the substrate to tint the substrate, and so that the substrate sufficiently recovers its original volume and shape so that the substrate is compatible with ophthalmic lens use following removal of the solvent, trapping the dyes in the substrate, and the dyes and their relative amounts are selected so that the tinted substrate exhibits an absorption spectrum useful for enhancing color vision.

Further, another U.S. Pat. No. 10,912,457, entitled “Lighting system for simulating conditions of color deficient vision and demonstrating effectiveness of color-blindness compensating eyewear,” discloses a lighting system for simulating conditions of color deficient vision and demonstrating effectiveness of color-blindness compensating eyewear and a method for demonstrating an ophthalmic lens. The lighting system includes a lighting apparatus and an optical filter.

As mentioned above, the lighting apparatus comprises a yellow light emitter emitting yellow light with a narrow-band spectral peak. The narrow-band spectral peak has a maximum wavelength between 570 nanometers and 600 nanometers and a band-width of between 1 nanometers and 40 nanometers at half maximum.

As mentioned above, the optical filter is designed to ameliorate the effects of color vision deficiency. The optical filter has a transmission spectrum comprising a spectral notch having a transmission minimum located between 570 and 600 nanometers and having a half-minimum width of 40 nanometers or less.

Further, another U.S. Pat. No. 11,327,342, entitled “Optical lens for correcting color vision,” discloses an optical lens device for correcting color vision for individuals with color vision deficiency. The optical lens device for correcting color vision includes a substrate and an absorbing dye which has at least a minimum light transmission factor.

As mentioned above, the minimum light transmission factor is in a visible spectrum at a wavelength ranging from 515 nm to 580 nm that is lower than or equal to 40%. The minimum light transmission factor can be rapidly varying transmission about 500 nm (decreasing transmission) and about 595 nm (increasing transmission).

Further, another U.S. Pat. No. 11,454,827, entitled “Optical filters affecting color vision in a desired manner and design method thereof by non-linear optimization,” discloses a computer implemented method for designing an optical filter for affecting color vision in a desired manner. The computer implemented method is suitable for the CIE (x,y) 1931 2-degree standard observer chromaticity space and CIE Standard Illuminant D65.

As mentioned above, the computer implemented method is applied to manufacture an optical filter and comprises a calculation of a candidate improved filter as compared to a current filter, with respect to a colorimetric performance measure, with simulating the current filter based on a current dye formula, with simulating a set of candidate filters based on a set of candidate incremental changes to the current dye formula.

Further, another U.S. Patent Application Publication No. 2021/0141132, entitled “Multi-band color vision filters and method by LP-optimization,” discloses a multi-band color vision filter device and method thereof. The multi-band color vision filter device has a spectral transmittance essentially formed as a multi-band filter.

As mentioned above, the multi-band filter comprises a plurality of pass-bands and a plurality of stop-bands, with the plurality of pass-bands interleaved with the plurality of stop-bands to form a plurality of interleaved pass-bands and a plurality of interleaved stop-bands.

As mentioned above, each of pass-band has a center, a width, a lower boundary, an upper boundary and a mean transmittance, with defining the lower boundary of a band as a center minus half the width, with defining the upper boundary of a band as a center plus half the width, with the center being located in the visible spectrum, between about 400 nm and about 700 nm, with the widths ranging between about 10 nm and about 110 nm.

As mentioned above, each of the stop-band has a center, a width, a lower boundary, an upper boundary and a mean transmittance, with defining the lower boundary of a band as a center minus half the width, with defining the upper boundary of a band as a center plus half the width, with the center being located in the visible spectrum, between about 400 nm and about 700 nm, with the widths ranging between about 10 nm and about 110 nm.

Further, another U.S. Patent Application Publication No. 2022/0075211, entitled “Spectral glare control eyewear for color blindness and low vision assistance,” discloses a spectral glare control eyewear device for color blindness and low vision assistance. The spectral glare control eyewear device comprises a lens device having a luminous transmittance between 60% and 85% and is suitable for the CIE (x,y) 1931 2-degree standard observer chromaticity space and CIE Standard Illuminant D65.

As mentioned above, the spectral glare control eyewear device has a spectral transmittance curve comprising: a maximum spectral transmittance between 460 nm and 510 nm less than 50 percent of the luminous transmittance; a minimum spectral transmittance between 460 nm and 500 nm less than or equal to 1%; a minimum spectral transmittance between 550 nm and 700 nm greater than 60%.

As mentioned above, the spectral transmittance curve of spectral glare control eyewear device further comprises: a mean transmittance between 400 nm and 450 nm at least 4 times greater than a mean transmittance between 460 nm and 500 nm. In another embodiment, the lens device has a non-central region outside of an optical center of the lens having the luminous transmittance between 40% and 60%.

However, there is a need of improving the conventional lens devices for providing a function of compensating red and green color deficient vision. The above-mentioned patents and patent application publications are incorporated herein by reference for purposes including, but not limited to, indicating the background of the present invention and illustrating the situation of the art.

### SUMMARY OF THE INVENTION

The primary objective of this invention is to provide a chroma enhancement optical lens device for compensating red and green color deficient vision and method thereof. The optical lens device includes a lens body and an optical filter provided therein. The lens body has an interference light absorbance portion, including a first green-confusion absorbance region and a second yellow orange-confusion absorbance region. The first green-confusion absorbance region has a first blue-green absorbance peak portion for absorbing at least one blue-green light (i.e., first unwanted light) from a light beam and the second yellow orange-confusion absorbance region has a second yellow-orange absorbance peak portion for absorbing at least one yellow-orange light (i.e., second unwanted light) from the light beam to provide red and green chroma enhancement in vision. Advantageously, the optical lens device of the present invention is successful in providing a function of compensating red and green color deficient vision.

The chroma enhancement optical lens device in accordance with an aspect of the present invention includes:
a lens body having a first lens surface and a second lens surface, with the first lens surface provided at a first side of the lens body, with the second lens surface provided at a second side of the lens body;
an optical filter provided between the first side and the second side of the lens body; and
an interference light absorbance portion provided to form the optical filter, with transmitting a light beam through the interference absorbance portion, with the interference light absorbance portion having a first green-confusion absorbance region and a second yellow orange-confusion absorbance region, with the first green-confusion absorbance region having a first blue-green absorbance peak portion, with the second yellow orange-confusion absorbance region having a second yellow-orange absorbance peak portion;
wherein the first blue-green absorbance peak portion is capable of absorbing at least one blue-green light of the light beam, with the first green-confusion absorbance region having a first wavelength range between 490 and 510 nm, and the second yellow-orange absorbance peak portion is capable of absorbing at least one yellow-orange light of the light beam, with the second green-confusion absorbance region having a second wavelength range between 585 nm and 605 nm, to provide red and green chroma enhancement in vision.

The compensating red and green color deficient vision method of a chroma enhancement optical lens device in accordance with another aspect of the present invention includes:
providing a lens body with an optical filter, with the lens body having an interference absorbance portion, with transmitting a light beam through the interference absorbance portion;
providing a first green-confusion absorbance region on the interference light absorbance portion, with the first green-confusion absorbance region having a first blue-green absorbance peak portion;
providing a second yellow orange-confusion absorbance region on the interference light absorbance portion, with the second yellow orange-confusion absorbance region having a second yellow-orange absorbance peak portion; and
the first blue-green absorbance peak portion absorbing at least one blue-green light of the light beam and the second yellow-orange absorbance peak portion absorbing at least one yellow-orange light of the light beam to provide red and green chroma enhancement in vision.

In a separate aspect of the present invention, the first blue-green absorbance peak portion of the first green-confusion absorbance region has a spectral range with a first absorbance above 50%, 60%, 70%, 80%, 90% or 95%.

In a further separate aspect of the present invention, the first blue-green absorbance peak portion of the first green-confusion absorbance region has a first maximum absorbance with a wavelength about 498 nm.

In yet a further separate aspect of the present invention, the second yellow-orange absorbance peak portion of the second yellow orange-confusion absorbance region has a spectral range with a second absorbance above 50%, 60%, 70%, 80%, 90% or 95%.

In yet a further separate aspect of the present invention, the second yellow-orange absorbance peak portion of the second yellow orange-confusion absorbance region has a second maximum absorbance with a wavelength about 595 nm.

In yet a further separate aspect of the present invention, the first blue-green absorbance peak portion of the first green-confusion absorbance region has a first absorbance and the second yellow-orange absorbance peak portion of the second yellow orange-confusion absorbance region has a second absorbance, with adjusting a predetermined ratio of first absorbance to second absorbance to provide various degrees of compensating red and green color deficient vision.

In yet a further separate aspect of the present invention, the first blue-green absorbance peak portion of the first green-confusion absorbance region has a first absorbance and the second yellow-orange absorbance peak portion of the second yellow orange-confusion absorbance region has a second absorbance, with adjusting a relatively higher ratio of first absorbance to second absorbance to provide various degrees of compensating blue green color deficient vision.

In yet a further separate aspect of the present invention, the first blue-green absorbance peak portion of the first green-confusion absorbance region has a first absorbance and the second yellow-orange absorbance peak portion of the second yellow orange-confusion absorbance region has a second absorbance, with adjusting a relatively lower ratio of first absorbance to second absorbance to provide various degrees of compensating yellow orange color deficient vision.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of a chroma enhancement optical lens device for compensating red and green color deficient vision in accordance with a first preferred embodiment of the present invention.

FIG. 2 is a schematic side view of a chroma enhancement optical lens device for compensating red and green color deficient vision in accordance with a second preferred embodiment of the present invention.

FIG. 2A is a schematic side view of a chroma enhancement optical lens device for compensating red and green color deficient vision in accordance with another preferred embodiment of the present invention.

FIG. 3 is a flow chart of a compensating red and green color deficient vision method of a chroma enhancement optical lens device in accordance with a preferred embodiment of the present invention.

FIG. 4 is a chart illustrating a first filtered spectral band of a chroma enhancement optical lens device for compensating red and green color deficient vision and method thereof in accordance with a preferred embodiment of the present invention.

FIG. 5 is a chart illustrating a second filtered spectral band of a chroma enhancement optical lens device for compensating red and green color deficient vision and method thereof in accordance with another preferred embodiment of the present invention.

### DETAILED DESCRIPTION OF THE INVENTION

It is noted that a chroma enhancement optical lens device for compensating red and green color deficient vision and method thereof in accordance with the preferred embodiment of the present invention can be applicable to various glasses, various vision corrective glasses (i.e., ophthalmic glasses), various color deficient vision compensation glasses, various sunglasses, various smart glasses, various sport glasses (including motorcycle-riding glasses), various goggles, various VR wearable glasses devices, various AR wearable glasses devices or other optical devices such as 3D glasses, which are not limitative of the present invention.

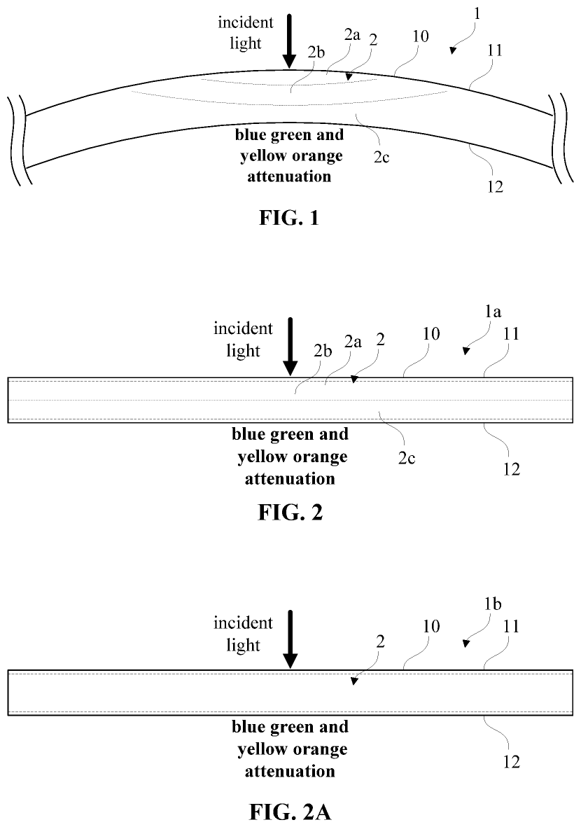

FIG. 1 shows a schematic side view of a chroma enhancement optical lens device for compensating red and green color deficient vision in accordance with a first preferred embodiment of the present invention. Referring now to FIG. 1, the chroma enhancement optical lens device for compensating red and green color deficient vision in accordance with the first preferred embodiment of the present invention includes a first lens body 1, an optical filter 10 and an interference light absorbance portion 2.

With continued reference to FIG. 1, by way of example, the first lens body 1 is formed from a curved-surface lens body such as a corrective glasses, a sunglasses, a sport glasses, a reading glasses, a helmet face shield, a safety helmet face shield (including welding helmet face shield), or other curved-surface lens bodies. The first lens body 1 is a transparent lens body with a preferred curvature.

Still referring to FIG. 1, by way of example, the first lens body 1 has a first lens surface 11 located at a first side (i.e. outer side as a light incident side) and a second lens surface 12 located at a second side (i.e. inner side as a light filtered side). The first lens body 1 is serially formed with a first filtering layer (or area) provided with a first dye material and a first additive material, a second filtering layer (or area) provided with a second dye material and a second additive material, and a third filtering layer (or area) provided with a third dye material and a third additive material.

FIG. 2 shows a schematic side view of a chroma enhancement optical lens device for compensating red and green color deficient vision in accordance with a second preferred embodiment of the present invention, corresponding to that shown in FIG. 1. Turning now to FIG. 2, in comparison with the first embodiment, the chroma enhancement optical lens device in accordance with the second preferred embodiment of the present invention includes a second lens body 1a, an optical filter 10 and an interference light absorbance portion 2.

With continued reference to FIG. 2, by way of example, the second lens body 1a is formed from a flat-surface lens body, a thin layer lens body or a multiple layer lens body such as a TV screen glasses, a screen protector for 3C electronic devices, or other flat-surface lens bodies.

Referring back to FIGS. 1 and 2, by way of example, the optical filter 10 is suitably provided between the first lens surface 11 and the second lens surface 12 of the first lens body 1 or the second lens body 1a. Accordingly, the optical filter 10 is capable of filtering incident light from the first lens surface 11 to the second lens surface 12, as best shown by arrows in FIGS. 1 and 2.

Still referring to FIGS. 1 and 2, by way of example, the interference light absorbance portion 2 is suitably provided at a preferred position of the optical filter 10 by preferred manners or means. In a preferred embodiment, the interference light absorbance portion 2 has multiple peaks of transmittance area and is made from at least one dye powder material. The dye powder material may be selected from FORESIGHT™ products (e.g., FORESIGHT (λ_{Max}=498 nm), FORESIGHT (λ_{Max}=595 nm) or other equivalent dye powder materials).

With continued reference to FIGS. 1 and 2, by way of example, the interference light absorbance portion 2 has a first green-confusion absorbance region and a second yellow orange-confusion absorbance region. A light beam, as best shown by arrows in FIGS. 1 and 2, transmits through the interference light absorbance portion 2 which filters it to form a spectrum band, with the interference light absorbance portion 2 providing at least one blue green attenuation area and at least one yellow orange attenuation area, as best shown by dotted lines in FIGS. 1 and 2. The attenuation areas of the interference light absorbance portion 2 can be made of various concentrations of absorbent materials.

With continued reference to FIGS. 1 and 2, by way of example, the interference light absorbance portion 2 includes a first interference light absorbance portion 2a, a second interference light absorbance portion 2b and a third interference light absorbance portion 2c which are made of various different concentrations of dye powder materials. In a preferred embodiment, the first interference light absorbance portion 2a, the second interference light absorbance portion 2b and the third interference light absorbance portion 2c of the interference light absorbance portion 2 are selectively added with a predetermined dye material (e.g., blue dye, green dye or other color dyes).

With continued reference to FIGS. 1 and 2, by way of example, the first interference light absorbance portion 2a, the second interference light absorbance portion 2b and the third interference light absorbance portion 2c of the interference light absorbance portion 2 can be arranged with different orders of blue green absorbance layer and yellow orange absorbance layer, according to various needs, to selectively absorb blue green rays and yellow orange rays for whole-visible-spectrum enhancement.

FIG. 2A shows a chroma enhancement optical lens device for compensating red and green color deficient vision in accordance with another preferred embodiment of the present invention, corresponding to that shown in FIG. 2. Referring now to FIGS. 2 and 2A, the chroma enhancement optical lens device in accordance with the preferred embodiment of the present invention includes a third lens body 1b, an optical filter 10 and an interference light absorbance portion 2, with integrating the first interference light absorbance portion 2a, the second interference light absorbance portion 2b and the third interference light absorbance portion 2c, as best shown in FIG. 2, into a single layer to form the interference light absorbance portion 2, as best shown in FIG. 2A.

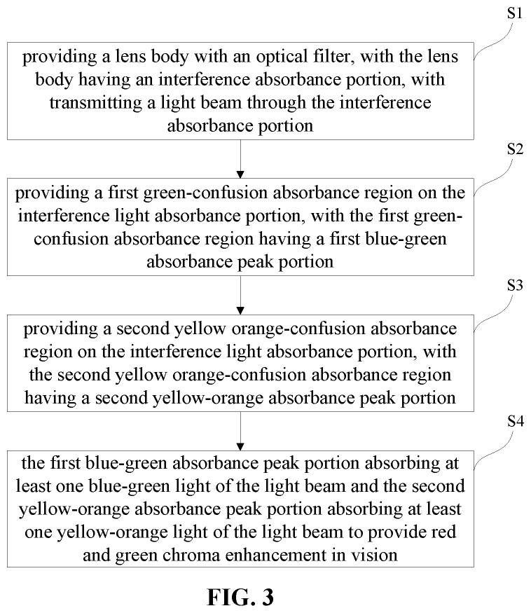

FIG. 3 shows a flow chart of a compensating red and green color deficient vision method of a chroma enhancement optical lens device in accordance with a preferred embodiment of the present invention. Referring now to FIGS. 1, 2, 2A and 3, by way of example, the compensating red and green color deficient vision method in accordance with a preferred embodiment of the present invention includes step 1: providing the lens body 1 with the optical filter 10, with the lens body 1 having the interference light absorbance portion 2, with capable of transmitting a light beam (i.e., rays) through the interference light absorbance portion 2.

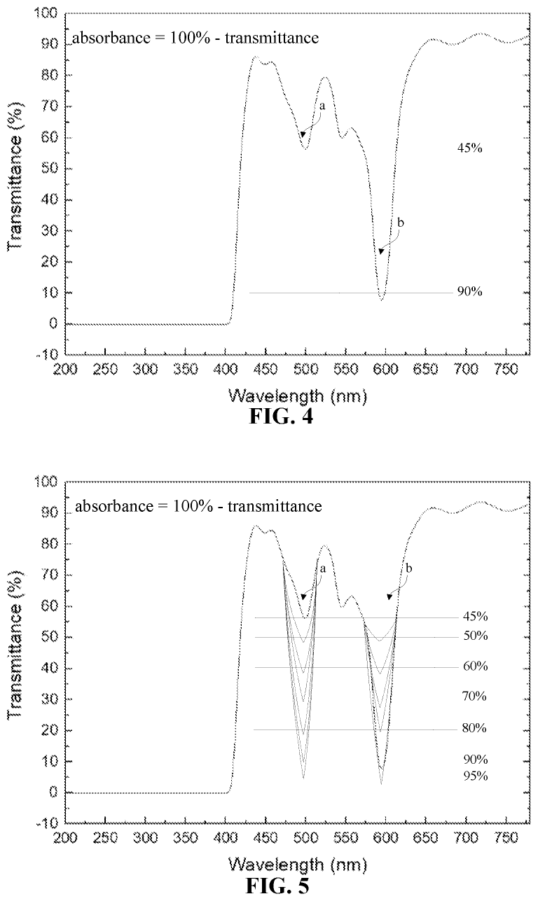

With continued reference to FIGS. 1, 2, 2A and 3, by way of example, the compensating red and green color deficient vision method in accordance with a preferred embodiment of the present invention includes step 2: providing a first green-confusion absorbance region of optical spectrum on the interference light absorbance portion 2, with the first green-confusion absorbance region having a first blue-green absorbance peak portion, as identified as “a” in FIGS. 4 and 5, so as to provide a first spectral vision buffering area to reduce a degree of color confusion between blue and green.

With continued reference to FIGS. 1, 2, 2A and 3, by way of example, the compensating red and green color deficient vision method in accordance with a preferred embodiment of the present invention includes step 3: providing a second yellow orange-confusion absorbance region of optical spectrum on the interference light absorbance portion 2, with the second yellow orange-confusion absorbance region having a second yellow-orange absorbance peak portion, as identified as “b” in FIGS. 4 and 5, so as to provide a second spectral vision buffering area to reduce a degree of color confusion between red and green, between red and yellow or between red and orange.

With continued reference to FIGS. 1, 2, 2A and 3, by way of example, the compensating red and green color deficient vision method in accordance with a preferred embodiment of the present invention includes step 4: the first blue-green absorbance peak portion absorbing at least one blue-green light of the light beam so as to provide a relatively strengthened green light beside the first green-confusion absorbance region (i.e., blue green region) and the second yellow-orange absorbance peak portion absorbing at least one yellow-orange light of the light beam so as to provide a relatively strengthened green light beside the second yellow orange-confusion absorbance region (i.e., yellow orange region) to thereby provide red and green chroma enhancement in vision.

Still referring to FIGS. 1, 2, 2A and 3, by way of example, the first green-confusion absorbance region “a” has a first wavelength range between 475 nm and 525 nm, 480 nm and 520 nm, 485 nm and 515 nm, 490 nm and 510 nm or other combination ranges thereof to form the first spectral vision buffering area to thereby strengthen a wavelength about 510 nm, about 515 nm, about 520 nm or about 525 nm which is a relatively strengthened green light near blue.

Still referring to FIGS. 1, 2, 2A and 3, by way of example, the second yellow orange-confusion absorbance region “b” has a second wavelength range between 575 nm and 615 nm, 580 nm and 610 nm, 585 nm and 605 nm or other combination ranges thereof to form the second spectral vision buffering area to thereby strengthen a wavelength about 605 nm, about 610 nm or about 615 nm which is a relatively strengthened green light near yellow.

FIG. 4 shows a chart illustrating a first filtered spectral band of a chroma enhancement optical lens device for compensating red and green color deficient vision and method thereof in accordance with a preferred embodiment of the present invention. Referring now to FIGS. 1, 2, 2A and 4, by way of example, the first filtered spectral band transmitting through the interference light absorbance portion 2 has a plurality of green-confusion absorbance regions, including a first blue-green absorbance peak portion of first green-confusion absorbance region “a” (shown at left peak in FIG. 4) and a second yellow orange-confusion absorbance region “b” (shown at right peak in FIG. 4), which are made from a preferred concentration of FORESIGHT™ products (λ_{Max}=498 nm) between about 0.03 g/kg PC and about 0.015 g/kg PC and FORESIGHT™ products (λ_{Max}=595 nm) between about 0.03 g/kg PC and about 0.015 g/kg PC or other equivalent dye materials.

With continued reference to FIGS. 1, 2, 2A and 4, by way of example, the first blue-green absorbance peak portion of first green-confusion absorbance region “a” has a first wavelength range between 475 nm and 525 nm, 480 nm and 520 nm, 485 nm and 515 nm, or 490 nm and 510 nm such that the first green-confusion absorbance region “a” performs as a blue-green separating area; the second yellow-orange absorbance peak portion of second yellow orange-confusion absorbance region “b” has a second wavelength range between 575 nm and 615 nm, 580 nm and 610 nm, or 585 nm and 605 nm such that the second yellow orange-confusion absorbance region “b” performs as a yellow-orange separating area.

With continued reference to FIGS. 1, 2, 2A and 4, by way of example, in a preferred embodiment the first green-confusion absorbance region “a” has a first wavelength range between 475 nm and 525 nm, 480 nm and 520 nm, 485 nm and 515 nm, or 490 nm and 510 nm, with ranging the second yellow-orange absorbance peak portion of second yellow orange-confusion absorbance region “b” within the second wavelength range between 575 nm and 615 nm, 580 nm and 610 nm, or 585 nm and 605 nm.

With continued reference to FIGS. 1, 2, 2A and 4, by way of example, in another preferred embodiment the second yellow orange-confusion absorbance region “b” has a second wavelength range between 575 nm and 615 nm, 580 nm and 610 nm, or 585 nm and 605 nm, with ranging the first blue-green absorbance peak portion of first green-confusion absorbance region “a” within the first wavelength range between 475 nm and 525 nm, 480 nm and 520 nm, 485 nm and 515 nm, or 490 nm and 510 nm.

With continued reference to FIGS. 1, 2, 2A and 4, by way of example, the first blue-green absorbance peak portion of the first green-confusion absorbance region “a” has a first maximum absorbance with a wavelength about 498 nm and the second yellow-orange absorbance peak portion of the second yellow orange-confusion absorbance region “b” has a second maximum absorbance with a wavelength about 595 nm.

With continued reference to FIGS. 1, 2, 2A and 4, by way of example, the first blue-green absorbance peak portion of the first green-confusion absorbance region “a” has a first absorbance and the second yellow-orange absorbance peak portion of the second yellow orange-confusion absorbance region “b” has a second absorbance, with adjusting a predetermined ratio of first absorbance to second absorbance (e.g., first absorbance/second absorbance≈45/90 as best shown in FIG. 4) to provide various degrees of compensating red and green color deficient vision, with selecting the ratios equal to, greater than or less than 1, as best shown at dotted lines in FIG. 5.

FIG. 5 shows a chart illustrating a second filtered spectral band of a chroma enhancement optical lens device for compensating red and green color deficient vision and method thereof in accordance with another preferred embodiment of the present invention. Referring now to FIGS. 1, 2, 2A and 5, by way of example, the first blue-green absorbance peak portion of the first green-confusion absorbance region “a” has a first absorbance and the second yellow-orange absorbance peak portion of the second yellow orange-confusion absorbance region “b” has a second absorbance, with adjusting a predetermined ratio of first absorbance to second absorbance to provide various degrees of compensating red and green color deficient vision.

With continued reference to FIGS. 1, 2, 2A and 5, by way of example, according to a degree of color confusion, the predetermined ratio of first absorbance to second absorbance can be adjusted for compensating red and green color deficient vision. In a preferred embodiment, the predetermined ratio of first absorbance to second absorbance may be greater than 1 for compensating blue green color deficient vision. In another preferred embodiment, the predetermined ratio of first absorbance to second absorbance may be less than 1 for compensating yellow orange color deficient vision. In another preferred embodiment, the predetermined ratio of first absorbance to second absorbance may equal 1 for compensating blue green and yellow orange color deficient vision.

With continued reference to FIGS. 1, 2, 2A and 5, by way of example, the first blue-green absorbance peak portion of the first green-confusion absorbance region “a” selectively has a spectral range with a first absorbance above 50%, 60%, 70%, 80%, 90% or 95%, as best shown at left dotted lines in FIG. 5; the second yellow-orange absorbance peak portion of the second yellow orange-confusion absorbance region “b” selectively has a spectral range with a second absorbance above 50%, 60%, 70%, 80%, 90% or 95%, as best shown at right dotted lines in FIG. 5. The first absorbance and the second absorbance can be selected in any form of combination (e.g., 50% first absorbance selectively combined with one of 50%, 60%, 70%, 80%, 90% or 95% of second absorbance, 60% first absorbance selectively combined with one of 50%, 60%, 70%, 80%, 90% or 95% second absorbance, 70% first absorbance selectively combined with one of 50%, 60%, 70%, 80%, 90% or 95% second absorbance, 80% first absorbance selectively combined with one of 50%, 60%, 70%, 80%, 90% or 95% second absorbance, 90% first absorbance selectively combined with one of 50%, 60%, 70%, 80%, 90% or 95% second absorbance, or 95% first absorbance selectively combined with one of 50%, 60%, 70%, 80%, 90% or 95% second absorbance) to provide various degrees of compensating red and green color deficient vision.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. A chroma enhancement optical lens device for compensating red and green color deficient vision comprising:
a lens body having a first lens surface and a second lens surface, with the first lens surface provided at a first side of the lens body, with the second lens surface provided at a second side of the lens body;
an optical filter provided between the first side and the second side of the lens body; and
an interference light absorbance portion provided to form the optical filter, with transmitting a light beam through the interference absorbance portion, with the interference light absorbance portion having a first green-confusion absorbance region and a second yellow orange-confusion absorbance region, with the first green-confusion absorbance region having a first blue-green absorbance peak portion, with the second yellow orange-confusion absorbance region having a second yellow-orange absorbance peak portion;
wherein the first blue-green absorbance peak portion is capable of absorbing at least one blue-green light of the light beam, with the first green-confusion absorbance region having a first wavelength range between 490 and 510 nm, and the second yellow-orange absorbance peak portion is capable of absorbing at least one yellow-orange light of the light beam, with the second green-confusion absorbance region having a second wavelength range between 585 nm and 605 nm, to provide red and green chroma enhancement in vision.

2. The chroma enhancement optical lens device as defined in claim 1, wherein the first blue-green absorbance peak portion of the first green-confusion absorbance region has a spectral range with a first absorbance above 50%, 60%, 70%, 80%, 90% or 95%.

3. The chroma enhancement optical lens device as defined in claim 1, wherein the first blue-green absorbance peak portion of the first green-confusion absorbance region has a first maximum absorbance with a wavelength about 498 nm.

4. The chroma enhancement optical lens device as defined in claim 1, wherein the second yellow-orange absorbance peak portion of the second yellow orange-confusion absorbance region has a spectral range with a second absorbance above 50%, 60%, 70%, 80%, 90% or 95%.

5. The chroma enhancement optical lens device as defined in claim 1, wherein the second yellow-orange absorbance peak portion of the second yellow orange-confusion absorbance region has a second maximum absorbance with a wavelength about 595 nm.

6. The chroma enhancement optical lens device as defined in claim 1, wherein the first blue-green absorbance peak portion of the first green-confusion absorbance region has a first absorbance and the second yellow-orange absorbance peak portion of the second yellow orange-confusion absorbance region has a second absorbance, with adjusting a predetermined ratio of first absorbance to second absorbance to provide a degree of compensating red and green color deficient vision.

7. The chroma enhancement optical lens device as defined in claim 1, wherein the first blue-green absorbance peak portion of the first green-confusion absorbance region has a first absorbance and the second yellow-orange absorbance peak portion of the second yellow orange-confusion absorbance region has a second absorbance, with adjusting a relatively higher ratio of first absorbance to second absorbance to provide a degree of compensating blue green color deficient vision.

8. The chroma enhancement optical lens device as defined in claim 1, wherein the first blue-green absorbance peak portion of the first green-confusion absorbance region has a first absorbance and the second yellow-orange absorbance peak portion of the second yellow orange-confusion absorbance region has a second absorbance, with adjusting a relatively lower ratio of first absorbance to second absorbance to provide a degree of compensating yellow orange color deficient vision.

9. A compensating red and green color deficient vision method for a chroma enhancement optical lens device comprising:
providing a lens body with an optical filter, with the lens body having an interference absorbance portion, with transmitting a light beam through the interference absorbance portion;
providing a first green-confusion absorbance region on the interference light absorbance portion, with the first green-confusion absorbance region having a first blue-green absorbance peak portion;
providing a second yellow orange-confusion absorbance region on the interference light absorbance portion, with the second yellow orange-confusion absorbance region having a second yellow-orange absorbance peak portion; and
the first blue-green absorbance peak portion absorbing at least one blue-green light of the light beam and the second yellow-orange absorbance peak portion absorbing at least one yellow-orange light of the light beam to provide red and green chroma enhancement in vision.

10. The compensating red and green color deficient vision method as defined in claim 9, wherein the first blue-green absorbance peak portion of the first green-confusion absorbance region has a spectral range with a first absorbance above 50%, 60%, 70%, 80%, 90% or 95%.

11. The compensating red and green color deficient vision method as defined in claim 9, wherein the first blue-green absorbance peak portion of the first green-confusion absorbance region has a first maximum absorbance with a wavelength about 498 nm.

12. The compensating red and green color deficient vision method as defined in claim 9, wherein the second yellow-orange absorbance peak portion of the second yellow orange-confusion absorbance region has a spectral range with a second absorbance above 50%, 60%, 70%, 80%, 90% or 95%.

13. The compensating red and green color deficient vision method as defined in claim 9, wherein the second yellow-orange absorbance peak portion of the second yellow orange-confusion absorbance region has a second maximum absorbance with a wavelength about 595 nm.

14. The compensating red and green color deficient vision method as defined in claim 9, wherein the first blue-green absorbance peak portion of the first green-confusion absorbance region has a first absorbance and the second yellow-orange absorbance peak portion of the second yellow orange-confusion absorbance region has a second absorbance, with adjusting a predetermined ratio of first absorbance to second absorbance to provide a degree of compensating red and green color deficient vision.

15. The compensating red and green color deficient vision method as defined in claim 9, wherein the first blue-green absorbance peak portion of the first green-confusion absorbance region has a first absorbance and the second yellow-orange absorbance peak portion of the second yellow orange-confusion absorbance region has a second absorbance, with adjusting a predetermined higher ratio of first absorbance to second absorbance to provide a degree of compensating blue green color deficient vision.

16. The compensating red and green color deficient vision method as defined in claim 9, wherein the first blue-green absorbance peak portion of the first green-confusion absorbance region has a first absorbance and the second yellow-orange absorbance peak portion of the second yellow orange-confusion absorbance region has a second absorbance, with adjusting a relatively lower ratio of first absorbance to second absorbance to provide a degree of compensating yellow orange color deficient vision.
